(19) United States
(12) Patent Application Publication
(10) Pub. No.: US 2006/0157405 A1
(43) Pub. Date: Jul. 20, 2006

(54) Water clarification system with coalescing media

(75) Inventors: Kris Odell Thacker, Rawson, OH (US); Howard Leander Montgomery, Findlay, OH (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Hancor, Inc.

(21) Appl. No.: 11/039,346

(22) Filed: Jan. 20, 2005

(51) Int. Cl. B01D 69/08

(52) U.S. Cl. 210/500.23

(57) ABSTRACT

A casing defines a cavity that extends along an axis and that has a top, a bottom and axially front and rear ends. The casing is configured to conduct a liquid along a flow path through the cavity from the front end to the rear end. A holding structure in the cavity defines a media chamber that can be filled with media for treating the liquid. The holding structure has a top passageway through which the liquid can flow downwardly into the media chamber and a rear passageway through which the liquid can flow rearwardly out of the media chamber. Blocking structures in the cavity constrain the flow path to extend through the top passageway into the media chamber and through the rear passageway out of the media chamber.

### TECHNICAL FIELD

The present invention relates to water clarification and oil-water separators.

### BACKGROUND

A water clarification system can be an oil-water separator used to separate contaminants from water. The water is typically rain runoff from a parking lot. The contaminants are typically oil, sludge and gravel. The separator may be buried in the ground. In operation, a mixture of the water and the contaminants enters the separator. The water exits the separator, while the contaminants are retained by and in the separator. The contaminants may be manually removed from the separator by way of manholes located along the top of the separator.

### SUMMARY

A casing defines a cavity that extends along an axis and that has a top, a bottom and axially front and rear ends. The casing is configured to conduct a liquid along a flow path through the cavity from the front end to the rear end. A holding structure in the cavity defines a media chamber that can be filled with media for treating the liquid. The holding structure has a top passageway through which the liquid can flow downwardly into the media chamber and a rear passageway through which the liquid can flow rearwardly out of the media chamber. Blocking structures in the cavity constrain the flow path to extend through the top passageway into the media chamber and through the rear passageway out of the media chamber.

Preferably, the blocking structures include a lower blocking structure extending from a front end of the top passageway down to the bottom of the cavity, configured to block the liquid from flowing rearwardly under and bypassing the top passageway. The blocking structures further include an upper blocking structure extending from a rear end of the top passageway upward, configured to block the liquid above the media chamber from flowing rearwardly onward to the rear end of the cavity without first flowing through the media chamber. The liquid can bypass the media chamber through a bypass passageway in the cavity only when the liquid is above a predetermined level. A porous bag in the media chamber contains the media.

### BRIEF DESCRIPTION OF THE DRAWINGS

FIG. 1 is a perspective view of a first water-contaminant separator;

FIG. 2 is a side sectional view of the first separator;

FIG. 3 is a perspective view of a weir of the first separator;

FIG. 4A is a sectional view of a plate coalescer of the first separator;

FIG. 4B is a sectional view taken at line 4B-4B of FIG. 4A;

FIG. 5 is a perspective view of a media coalescer of the first separator;

FIG. 6 is a perspective view of a basket of the media coalescer of FIG. 5;

FIG. 7 is a perspective view of a second water-contaminant separator;

FIG. 8 is a side sectional view of the second separator;

FIG. 9 is a perspective view of a weir of the second separator;

FIG. 10A is a sectional view of a plate coalescer of the second separator;

FIG. 10B is a sectional view taken at line 10B-10B of FIG. 10A;

FIG. 11 is an exploded view of a media coalescer of the second separator;

FIG. 12 is an assembled view of the media coalescer of FIG. 11; and

FIG. 13 is a side sectional view of the media coalescer of FIG. 11.

### DESCRIPTION

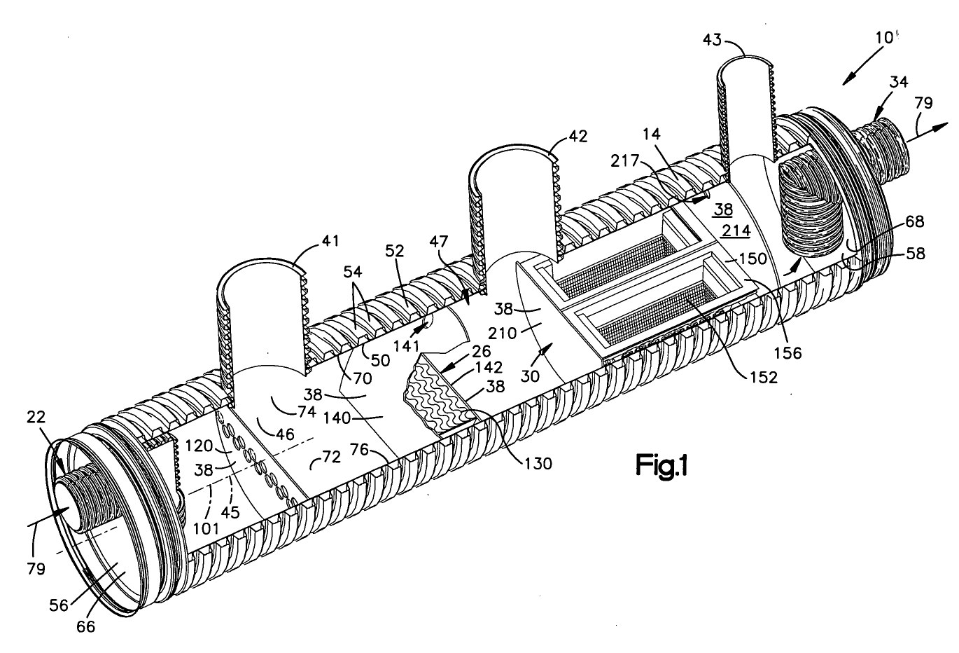

The apparatus 10 shown in FIG. 1 has parts which, as described below, are examples of the elements recited in the claims.

The apparatus 10 is a water-contaminant separator. The separator 10 is used to separate contaminants from a liquid. In this example, the liquid is water, such as rain runoff from a parking lot. The contaminants can be buoyant, such as oil and styrofoam debris, or sedimentary, such as sludge and gravel. The separator 10 includes a cylindrical casing 14. In operation, a mixture of the water and the contaminants enters the casing 14 through an inlet structure 22. The contaminants are initially either floating at the top of the water, settled at the bottom, or suspended in-between. A plate coalescer 26 and a media coalecser 30 within the casing 14 promote floating of the initially-suspended buoyant contaminants and settling of the initially-suspended sedimentary contaminants. As the water exits the tank structure 14 through an outlet structure 34, baffles 38 of various types within the casing 14 retain the floating and settled contaminants in the casing 14. The contaminants may be manually removed from the casing 14 through manways 41, 42 and 43 located along the top of the chamber 14.

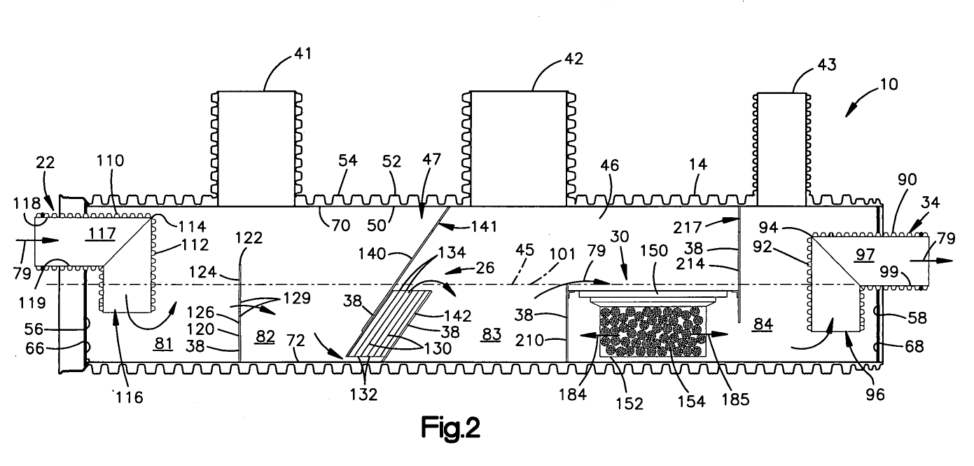

The separator 10 is configured to operate in an installed orientation shown in FIG. 2, typically buried in the ground. The various features of the separator 10 are described as follows with reference to the installed orientation.

The cylindrical casing 14 is centered on a horizontal axis 45. The casing 14 has an inner surface 46 that surrounds the axis 45 to define a cavity 47. In this example, the casing 14 comprises a cylindrical inner liner 50 surrounded by a corrugated wall 52 with circumferentially-extending corrugations 54. The inner liner 50 defines the inner surface 46 of the casing 14. Front and rear end walls 56 and 58 cap the casing 14 at axially front and rear ends 66 and 68 of the cavity 47.

The cavity 47 has a top 70, a bottom 72 and two opposite sides 74 and 76 (FIG. 1). As indicated by arrows 79, the chamber 14 is configured to conduct the mixture of the water and the contaminants rearward through the cavity 47 from the inlet structure 22 to the outlet structure 34.

The cavity 47 is divided by the baffles 38 into first, second, third and fourth compartments 81, 82, 83 and 84, as shown in FIG. 2. In each compartment 81, 82, 83 and 84, a portion of the initially-suspended contaminants rises upward or settles downward. The resulting floating and settled contaminants are inhibited by the baffles 38 from progressing along with water from one compartment 81, 82, 83 and 84 to the next.

The outlet structure 34 comprises a horizontal tube 90 and a vertical tube 92 joined at an elbow junction 94. The vertical tube 92 has an intake opening 96 within the fourth compartment 84. The vertical tube 92 extends from the intake opening 96 upward to the junction 94. The horizontal tube 90, in turn, extends from the junction 94 axially rearward through the rear wall 58.

The horizontal tube 90 has a horizontal channel 97. A bottom 99 of the horizontal channel 97 defines a nominal water line 101 within the cavity 47. The nominal water line 101 corresponds to the surface of the water in a normal flow condition of the separator 10. In this example, the nominal water line 101 coincides with the central axis 45 of the casing 14. The intake opening 96 is located midway between the nominal water line 101 and the bottom 72 of the cavity 47. This helps prevent both the floating and settled contaminants from exiting the cavity 47 through the intake opening 96.

Like the outlet structure 34, the inlet structure 22 comprises a horizontal tube 110 and a vertical tube 112 joined at an elbow junction 114. The horizontal tube 110 of the inlet structure 22 extends axially rearward through the front wall 56 to the elbow junction 114 within the first chamber 81. The vertical tube 112 extends downward from the junction 114 and has a discharge opening 116 within the first compartment 81.

The horizontal tube 110 has a horizontal inlet channel 117 through which water flows rearward toward the junction 114. The horizontal inlet channel 117 has a top 118 and a bottom 119, both located above the nominal water line 101. This impedes the water from draining out of the cavity 47 by way of the inlet structure 22.

The discharge opening 116 of the inlet structure 22 is submerged below the nominal water line 101. Accordingly, the water spilling down from the horizontal inlet channel 117 hits the nominal water line 101 inside the vertical inlet tube 112. Most of the resulting turbulence is thus confined to within the vertical tube 112, which reduces turbulence elsewhere within the cavity 47. This is beneficial, because turbulence detrimentally impedes rising and settling of the contaminants.

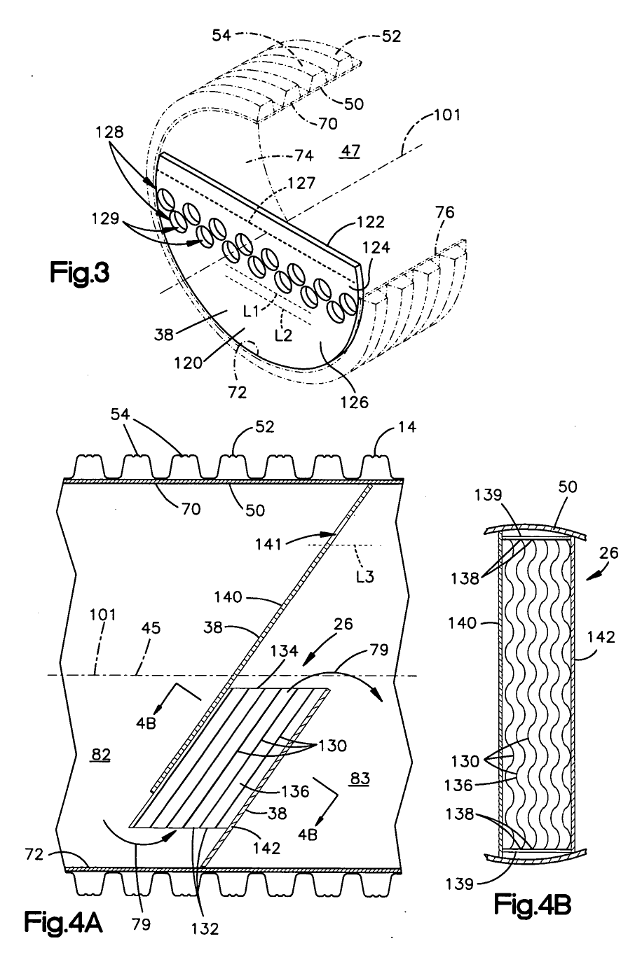

A transversely-extending (with respect to the axis 45) perforated weir 120 is one of the baffles 38 mentioned above. The weir 120 is located rearward of the inlet structure 22 and separates the first compartment 81 from the second compartment 82. As shown in FIG. 3, the weir 120 extends from the bottom 72 of the cavity 47 up to a horizontal top edge 122 of the weir 120. The top edge 122 extends transversely and horizontally from one side 74 of the casing 14 to the other side 76.

The top edge 122 of the weir 120 is located above the nominal water line, indicated in FIG. 3 axially by the dashed line 101 and transversely by dashed line 127. This prevents the mixture from flowing over and bypassing the weir 120 under normal flow conditions. However, the top edge 122 is spaced below the top 70 of the cavity 47, and, preferably, even lower than the top 118 of the horizontal inlet channel 117 (FIG. 2). The opening between the top edge 122 of the weir 120 and the top 70 of the cavity 47 is a bypass passageway through which the water can bypass the weir 120 during abnormally high flow conditions.

The weir 120 consists of a perforated upper section 124 and a non-perforated lower section 126. The perforated upper section 124 has two horizontal rows 128 of fluid flow holes 129 located below the nominal water line 101. The rows 128 are vertically overlapping. The holes 129 are separated from each other, with the holes 129 of one row 128 horizontally offset from adjacent holes 129 of the other row 129. Accordingly, the holes 129 of one row 128 are interleaved with, and staggered relative to, the holes 129 of the other row 128. This enables compact packing of the holes 129. The perforated upper section 124 filters out debris larger than the holes 129 from the water and retains it in the first compartment 81 (FIG. 2).

The lower section 126 is unperforated to prevent even small sediment from passing from the first compartment 81 to the second compartment 82. To this end, the weir 120 is free of fluid flow holes below a first level L1 located vertically halfway between the bottom 72 of the cavity 47 and the top edge 122. The weir 120 is also free of fluid flow holes 129 below a second level L2 vertically halfway between the bottom 72 of the cavity 47 and the nominal water line 127.

The plate coalescer 26, as shown in FIG. 2, is located rearward of the weir 120 between the second and third compartments 82 and 83. As shown in FIGS. 4A and 4B, the plate coalescer 26 comprises an inclined stack of corrugated plates 130. Each plate 130 extends from a bottom edge 132 of the plate 130 rearward and upward to a top edge 134 of the plate 130. The bottom edge 132 is spaced above the bottom 72 of the cavity 47, and the top edge 134 is spaced below the nominal water line 101. This configuration enables the water to enter the coalescer 26 from below, to flow rearward and rearward in-between the plates 130, and to exit the coalescer 26 at the top.

Each plate 130 is corrugated, with corrugations 136 extending rearward and upward fully from the bottom edge 132 to the top edge 134. The corrugations 136 are thus aligned along the direction of the water flow between the plates 130, as indicated by arrows 79. As shown in FIG. 4B, each corrugation 136 of each plate 130 is positioned directly above a corrugation 136 of the plate 130 just below it. Each plate 130 has two opposite side edges 138 received in respective grooves (not shown) in two opposite plate retainers 139.

Flow of the mixture rearwardly upward between the plates 130 shown in FIG. 4A promotes coalescing of the initially-suspended particles and droplets into agglomerates. Relative to the suspended particles and droplets, the agglomerates have more buoyancy for floating upward or more weight for settling downward. The floating agglomerates can flow out the top of the coalescer 26 into the third compartment 83 where they can float at the water surface 101. Similarly, the sedimentary agglomerates can be swept by the water out the top of the coalescer 26 and settle as sediment at the bottom of the third compartment 83. Alternatively, the sedimentary agglomerates can slide down the plates 130 to settle as sediment at the bottom 72 of the second compartment 82.

An upper coalescer baffle 140, which is one of the baffles 38 mentioned above, extends from a front one of the coalescer plates 130 upward to the casing 14. The upper coalescer baffle 140 prevents any floating contaminants in the second compartment 82 from migrating to the third compartment 83. The upper coalescer baffle 140 also prevents the mixture from flowing rearwardly over, and thus bypassing, the coalescer 26. A bypass flow opening 141 in the upper baffle 140 allows the mixture to bypass the plate coalescer 26 under high flow conditions when the water rises above a predetermined level L3.

A lower coalescer baffle 142 extends from a rear one of the plates 130 downward to the casing 14. The lower coalescer baffle 142 blocks the liquid under the plate coalescer 26 from flowing onward to the rear end 68 of the cavity 47 without first flowing upward through the coalescer 26. The lower coalescer baffle 142 also prevents any sediment in the second compartment 82 from migrating to the third compartment 83.

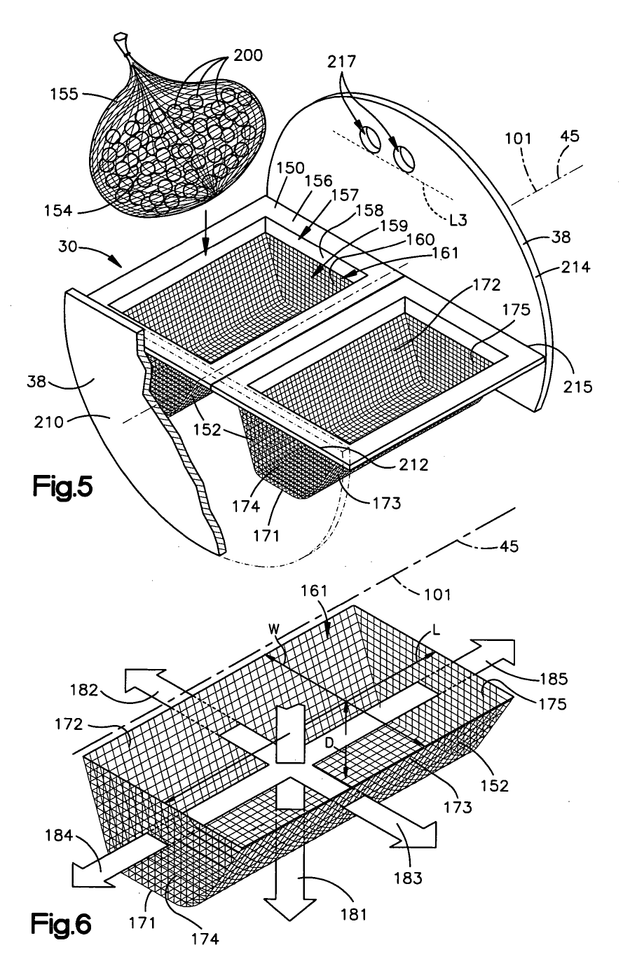

The media coalecser 30, as shown in FIG. 2, is located between of the plate coalescer 26 and the outlet structure 34, and between the third and fourth compartments 83 and 84. As shown in FIG. 5, the media coalecser 30 comprises a frame 150, two porous baskets 152, and coalescing media 154. When in use, the media 154 is contained in the baskets 152.

A porous bag 155 is used to contain the media 154 during transport to each basket 152. The media 154 is placed in the basket 152 along with the bag 155. While in use, the bag 155 prevents the water from sweeping the media 154 out of the basket 152. The media 154 is removed from the basket 152 by simply lifting the bag 155 out of the basket 152.

The frame 150 is located below the nominal water line 101. The frame 150 comprises a nonporous plate 156 extending horizontally from one side 74 (FIG. 1) of the casing 14 to the other side 76. The plate 156 has two side-by-side rectangular openings 157. From the two openings 157, two nonporous rectangular tubes 158 extend downward to two bottom openings 159.

The two porous baskets 152 hang down from the two tubes 158. Each basket 152 consists of a screen 160 extending downward from a top opening 161 of the basket 152. This top opening 161 coincides with the bottom opening 159 of the respective tube 158. The screen 160 passes the water while retaining the coalescing media 154. As shown in FIG. 6, the basket 152 is trough-shaped, with a porous bottom wall 171, porous opposite side walls 172 and 173, and porous front and rear walls 174 and 175.

The water flows by force of gravity into the basket 152 vertically downward through the top opening 161, as shown in FIG. 6. The water then flows through the coalescing media 154 (FIG. 5) in the basket 52. The water flows, further, out of the basket 152 in several directions. Specifically, the water can flow downward through the bottom wall 171. This flow is in a first direction 181 extending vertically downward through the top opening 161, perpendicular to the axis 45 of the casing 14 (FIG. 2). The water can flow out of the basket 152 also through the side walls 172 and 173. These flows are in horizontal second and third directions 182 and 183 that are opposite each other, perpendicular to the first direction 181 and perpendicular to axis 45 of the casing 14. The water can flow out of the basket 152 also through the front and rear walls 174 and 175. These flows are in a horizontal forward fourth direction 184 and a horizontal rearward fifth direction 185. These directions 184 and 185 are opposite each other, perpendicular to the first, second and third directions 181, 182 and 183, and parallel with the axis 45 of the casing 14. So as not to obstruct the water outflow in these directions 181, 182, 183, 184 and 185, the porous walls 171, 172, 173, 174 and 175 are all spaced from the casing 14.

Accordingly, the water can flow outward through of the basket 152 in multiple, mutually opposite or perpendicular, directions 181, 182, 183, 184 and 185, and those directions 181, 182, 183, 184 and 185 include both vertical and horizontal directions. These features beneficially decrease resistance to water flow. They also improve coalescing efficacy by reducing turbulence. For this purpose, a depth D of the basket 152 is preferably at least as large as the width W of the top opening 161. Additionally, the porous wall 160 extends downward sufficiently such that the surface area of the porous wall 160 is at least double the area encircled by the top opening 161. In this example, the area encircled by the top opening 161 equals the length L of the opening 161 times the width W of the opening 161.

The coalescing media 154 in this example, shown schematically in FIG. 5, is in the form of balls 200 known in the art. Examples of such balls 200 are Jaeger Tri-Packs® sold by Jaeger Products, Inc. of Houston, Tex. Each ball 200 comprises a network of plastic ribs (not shown). The network of ribs promotes coalescing of the initially-suspended particles and droplets into agglomerates that have sufficient buoyancy to float upward or sufficient weight to settle downward. Alternatively, the agglomerates can have sufficient size and adhesion to be caught or adhered by the rib network itself. When the balls 200 are deposited into the basket 152, each ball 200 can roll about due to its round shape, until the pile of balls 200 is compactly packed. The media 154 fills each basket 152 and extends upward into each tube 158. This ensures that the water flowing into the basket 152 through the top opening 161 and outward through the basket 152 must flow through the media 154.

A lower media coalecser baffle 210, shown in FIGS. 2 and 5, is one of the baffles 38 mentioned above. It is located in front of the baskets 152 and extends vertically from a front end 212 of the frame 150 downward to the casing 14. The lower baffle 210 also extends upward from the front end 212 almost to the nominal water line 101. The lower baffle 210 blocks the liquid from flowing under and bypassing the top opening 161 of the media coalescer 30. It also prevents sediment in the third compartment 83 from migrating to the fourth compartment 84.

An upper media coalecser baffle 214 is located rearward of the basket 152 and extends from a rear end 215 of the plate 156 upward to the casing 14. The upper baffle 214 also extends downward from the rear end 215 of the plate 156 without reaching the bottom 72 of the cavity 47. The upper baffle 214 blocks floating contaminants in the third compartment 83 from migrating to the fourth compartment 84. The upper baffle 214 also blocks the water above the top opening 161 from flowing rearwardly onward to the rear end 68 of the cavity 47 without first flowing through the top opening 161. A bypass flow opening 217 in the upper baffle 214 allows the water to bypass the media coalescer 30 under high flow conditions when the water rises above the predetermined level L3.

Thus, the upper baffle 214, the lower baffle 210 and the non-porous frame 150 together constrain the water flowing through the cavity 47 from the front end 66 to the rear end 68 to flow through the top opening 161 into the basket 152 under normal flow conditions.

The manways 41, 42 and 43, shown in FIG. 2, are designated first, second and third manways 41, 42 and 43. They are spaced axially along the casing 14 and extend upward from the top 70 of the cavity 47. The manways 41, 42 and 43 provide access to the various compartments 81, 82, 83 and 84 for manually removing the floating and settled contaminants that are retained in those respective compartments 81, 82, 83 and 84. Specifically, the first manway 41 is located above the weir 120 for removing the contaminants retained in the first and second compartment 81 and 82. The second manway 42 is located above the third compartment 83 for removing the contaminants retained in the third compartment 83, and also for removing the baskets 152 and the coalescing media 154. The third manway 43 is located above the fourth compartment 84 for removing the contaminants retained in the fourth compartment 84.

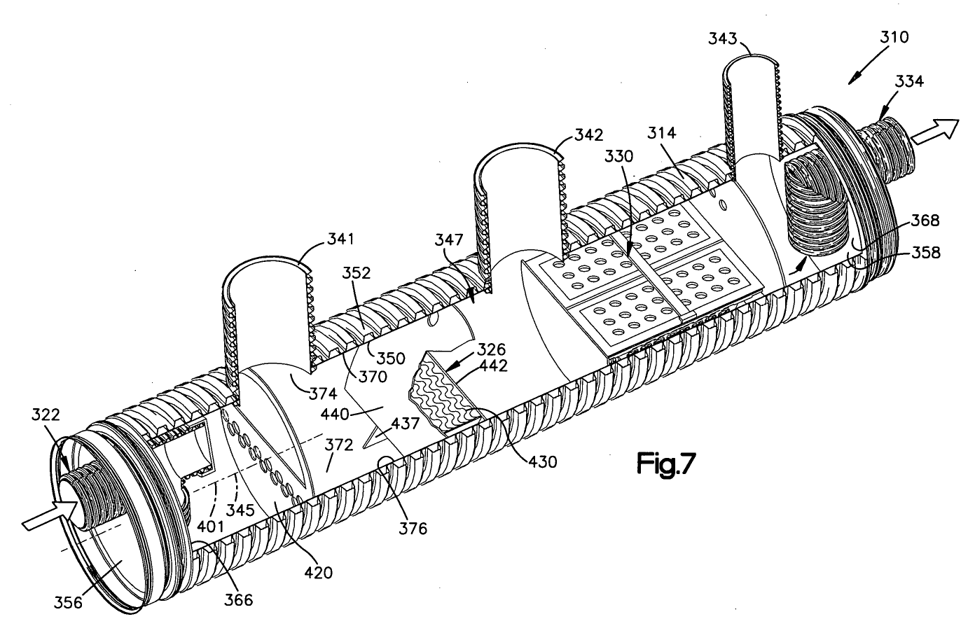

A second water-contaminant separator 310 is shown in FIG. 7. It has parts that correspond to those of the first separator 10. These include a cylindrical casing 314, an inlet structure 322, a perforated weir 420, a plate coalescer 326, a media coalescer 330, an outlet structure 334, manways 341, 342 and 343 and a central axis 345. The casing 314 comprises an inner liner 350 and a corrugated outer wall 352. The casing 314 defines a cavity 347 with axially front and rear ends 366 and 368, a top 370, a bottom 372 and opposite sides 374 and 376. Front and rear end walls 356 and 358 cap the casing 314 at the front and rear ends 366 and 368 of the cavity 347.

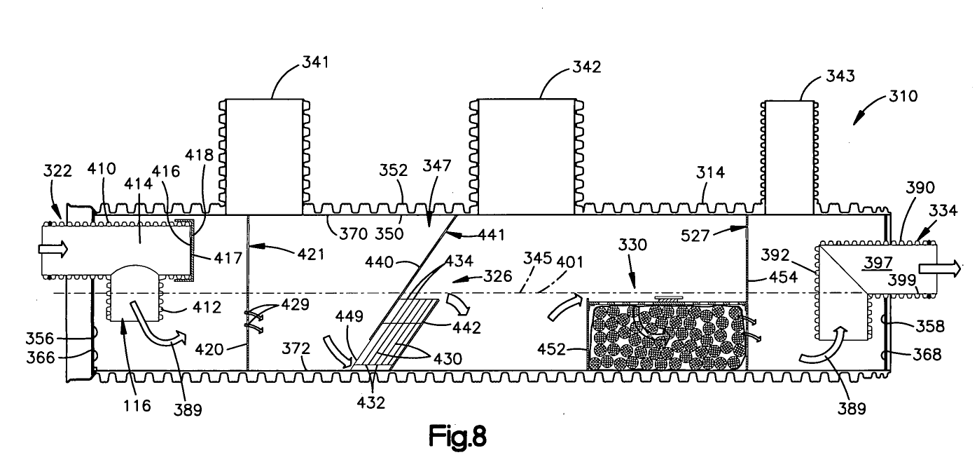

As shown in FIG. 8, the casing 314 conducts the liquid along a flow path, indicated by arrows 389, through the cavity 347 from the front end 366 of the cavity 347 to the rear end 368 of the cavity 347. The liquid can exit the cavity 347 through the outlet structure 334.

The outlet structure 334 includes a horizontal tube 390 joined to a vertical tube 392. The horizontal tube 390 defines a horizontal channel 397, the bottom 399 of which defines a nominal water level 401, which coincides with the central axis 345 of the casing 314 in this example.

The inlet structure 322 includes a horizontal tube 410 and a vertical tube 412 joined at a T-junction 414. The horizontal tube 410 has an access opening 416 at its rear end 417 for cleaning out the inlet structure 322. The access opening 413 is covered by a cap 418 removably attached to the rear end 417 of the horizontal tube 410.

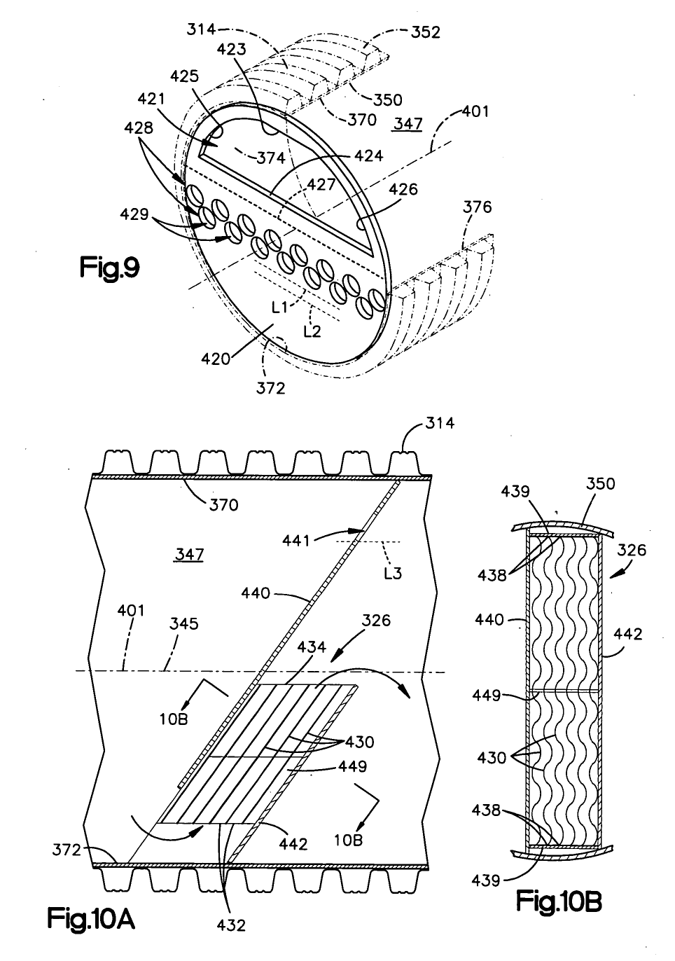

As shown in FIG. 9, the perforated weir 420 extends upward from the bottom 372 of the cavity 347. The weir 420 has rows 428 of filter holes 429 like the filter holes 129 (FIG. 3) of the first separator 10. The holes 429 are located below the nominal water line, indicated in FIG. 9 by axial and transverse dashed lines 401 and 427.

This weir 420 differs from the weir 20 (FIG. 3) of the first separator 10 in that it extends fully to the top 370 of the cavity 347 and adjoins the casing 314 about the full circumference of the cavity 347. The weir 420 includes a large bypass opening 421 above the nominal water line 401 and 427, through which the liquid can bypass the filter holes 429 during high flow conditions. The bypass opening 421 is defined by straight horizontal top and bottom edges 423 and 424 and opposite circular side edges 425 and 426. When the water level rises above the top edge 423 of the bypass opening 421, the weir 420 can retain floating contaminants that are above the top edge 423.

The weir 420 is free of fluid flow holes below a first level L1 located vertically halfway between the bottom 372 of the cavity 347 and the bottom edge 424 of the bypass opening 421. The weir 420 is also free of fluid flow holes below a second level L2 vertically halfway between the bottom 372 of the cavity 347 and the nominal water line 427.

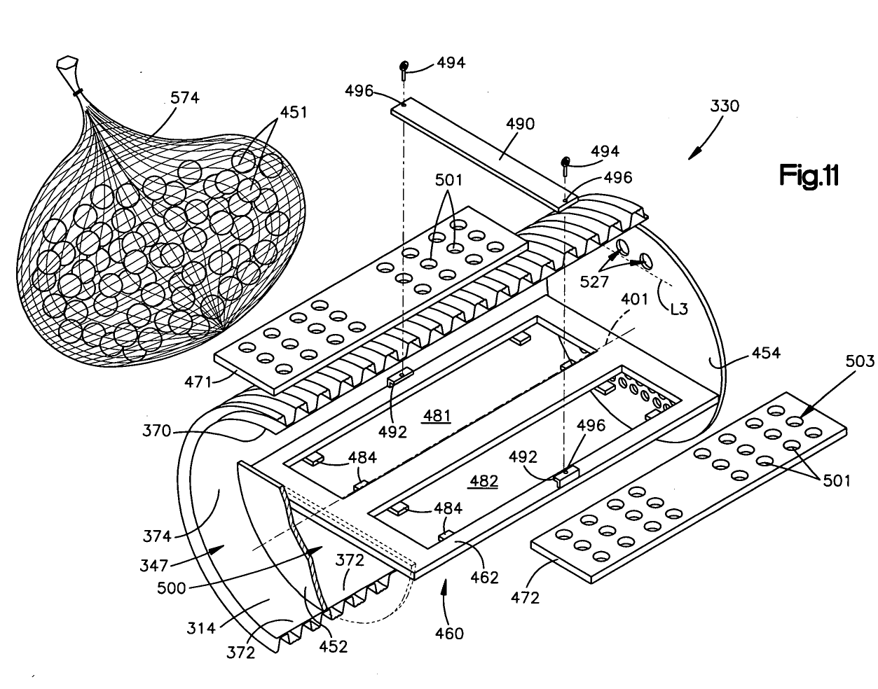

As shown in FIGS. 10A and 10B, the plate coalescer 326 includes an inclined stack of corrugated plates 430 like the plates 130 (FIG. 4A) in the first separator 10. Each plate 430 extends rearward and upward from its bottom end 432 to its top end 434. Two side plate retainers 439, like those of the first separator 10 (FIG. 4B), have grooves (not shown) for receiving the side edges 438 of the coalescing plates 430. A middle plate retainer 449 extends rearward and upward from the bottom 372 of the cavity 347 to a level midway between the bottom and top edges 432 and 434 of the coalescing plates 430. The middle plate retainer 449 has slits (not shown) that closely receive the coalescing plates 430 to stabilize the coalescing plates 430. The coalescing plates 430 can be withdrawn from the plate retainers 439 and 449 for cleaning and inserted back in place.

As shown in FIG. 10A, an upper plate coalescer baffle 440 is like the upper coalescer baffle 140 (FIG. 4A) of the first separator 10. It retains floating contaminants. It also blocks the liquid from flowing rearwardly over and bypassing the plate coalescer 426. A bypass opening 441 in the upper baffle 440 allows the water to bypass the plate coalescer 326 when the water rises above the predetermined level L3.

A lower coalescer baffle 442 is like the lower coalescer baffle 142 (FIG. 4A) of the first separator 10. It blocks the liquid under the coalescer 326 from flowing rearwardly onward to the rear end 368 (FIG. 8) of the cavity 347 without first flowing upward through the coalescer 326. It also retains settled contaminants.

As shown in FIG. 11, the media coalescer 330 is a holding structure for holding water treatment media. The media in this example is coalescing media comprising coalescing balls 451. However, the media can be any media for treatment of the liquid. This includes chemical release agents, scrubbing agents, absorbent packs, and filtration media.

The holding structure 330 includes front and rear retaining walls 452 and 454 and a cover structure 460. The cover structure 460 includes a rectangular frame 462 that extends from the front retaining wall 452 to the rear retaining wall 454, and from one side 374 of the cavity 347 to the opposite side 376 (FIG. 7) of the cavity 347. Two perforated cover plates 471 and 472 are closely received in corresponding rectangular openings 481 and 482 in the frame 462, and rest on support tabs 484 projecting from the frame 462. The cover plates 471 and 472 are held down by a bar 490 that is captured at its opposite ends by respective brackets 492. At each end of the bar 490, a pin 494 is inserted through holes 496 in the respective bracket 492, the bar 490, and the frame 462 to prevent the bar 490 from slipping out of the brackets 492.

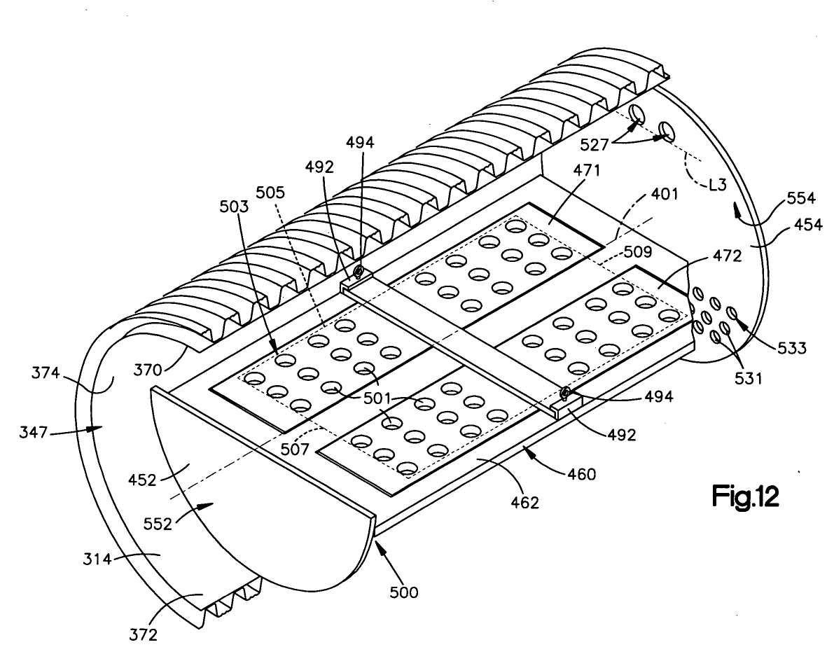

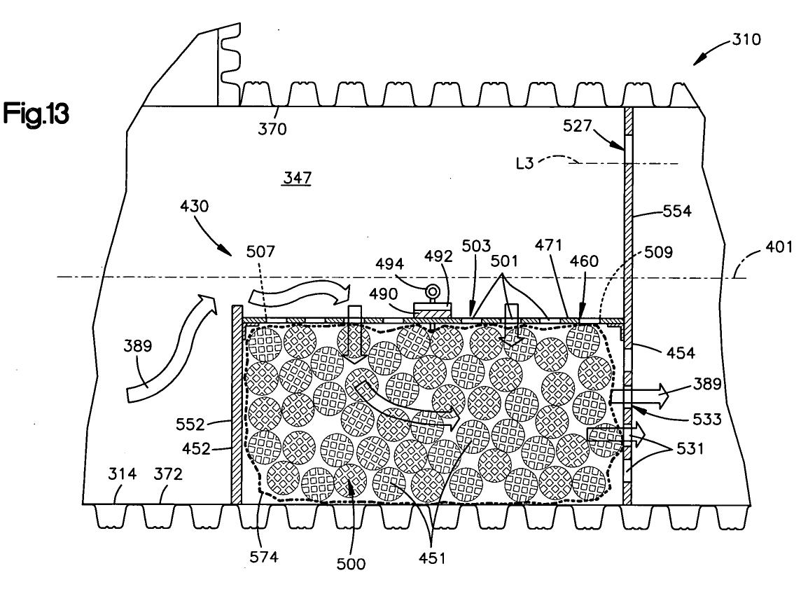

As shown in FIG. 12, a media chamber 500 is defined axially by and between the retaining walls 452 and 454 and defined vertically by and between the cover structure 460 and the bottom 372 of the cavity 347. The media chamber 500 can be filled with the media 451 to define a treatment zone, specifically a coalescing zone in this example, in which the treatment of the liquid occurs.

The cover structure 460 extends completely over the chamber 500. Each cover plate 471 and 472 of the cover structure 460 is perforated with an array of holes 501. The holes 501 together comprise a top passageway 503 through which the liquid can flow downward into the media chamber 500. The periphery of the top passageway 503 is denoted by an imaginary dashed rectangular line 505 with front and rear ends 507 and 509. The cover structure 460, including the top passageway 503, is spaced below the nominal water line 401.

The rear retaining wall 454 extends from the bottom 372 of the cavity 347 to the top 370 of the cavity 347, and adjoins the casing 314 about the full circumference of the cavity 347. The rear wall 454 has two bypass openings 527, and is unperforated from the bottom level L3 of the bypass openings 527 down to the cover structure 460. Below the cover structure 460, the rear wall 454 is perforated by an array of flow holes 531 comprising a rear passageway 533 through which the liquid can flow rearwardly out of the media chamber 500.

The front retaining wall 452 is not perforated. It extends upward from the bottom 372 of the cavity 347 to a level between the cover structure 460 and the nominal water line 401.

As shown in FIG. 13, the separator 310 has blocking structures that together constrain the flow path 389 to extend through the top passageway 503 into the chamber 500 and through the rear passageway 513 out of the chamber 500. These blocking structures include lower and upper blocking structures 552 and 554.

The lower blocking structure 552 includes unperforated portions of the cover structure 460 and front retaining wall 452. The lower blocking structure 552 extends from the front end 507 of the top passageway 503 forward to the front wall 452 and, from there, downward to the bottom 372 of the cavity 347. It blocks the liquid outside the media chamber 500 from rearwardly entering the chamber 500 anywhere below the top passageway 503. It also blocks the liquid in the media chamber 500 from forwardly exiting the chamber through the front of the chamber 500.

The upper blocking structure 554 includes unperforated portions of the cover structure 460 and rear wall 454. The upper blocking structure 554 extends from the rear end 509 of the top passageway 503 rearward to the rear wall 454 and, from there, upward to the bypass openings 527 at level L3. It blocks any of the liquid above the top passage 503 from flowing rearwardly onward to the rear end 368 (FIG. 8) of the cavity 347 without first flowing through the top passage 503. The bypass openings 527 enable the liquid to bypass the media chamber 500 when, and only when, the liquid is above the predetermined level L3.

The blocking structures further include a portion of the casing 314 that bounds the media chamber 500 at the bottom and sides of the chamber 500. This portion of the casing 314 blocks the liquid in the chamber 500 from exiting the chamber 500 downward or sideways through the bottom or sides of the chamber 500. This, along with the front retaining wall 452, constrains the liquid entering the chamber 500 through the top passageway 503 to exit the chamber 500 only through the rear passageway 533.

A porous bag 574 contains the media 451 during transport to the media chamber 500. The media 451 is placed in the chamber 500 along with the bag 574. The bag 574 helps prevent the water from sweeping the media 451 out of the chamber 500. The media 451 can be removed from the chamber 500 by simply lifting the bag 574 out of the chamber 500.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have elements that do not differ from the literal language of the claims, or if they include equivalent structural elements with insubstantial differences from the literal language of the claims.

1. An apparatus comprising:
a casing defining a cavity that extends along an axis and that has a top, a bottom and axially front and rear ends, and is configured to conduct a liquid along a flow path through the cavity from the front end to the rear end;
a holding structure, in the cavity, defining a media chamber that can be filled with media for treating the liquid, the holding structure having a top passageway through which the liquid can flow downwardly into the chamber and a rear passageway through which the liquid can flow rearwardly out of the chamber; and
blocking structures in the cavity that constrain the flow path to extend through the top passageway into the media chamber and through the rear passageway out of the media chamber.

2. The apparatus of claim 1 wherein the blocking structures include a transversely-extending lower blocking structure extending from a front end of the top passageway down to the bottom of the cavity, configured to block the liquid from flowing rearwardly under and bypassing the top passageway.

3. The apparatus of claim 2 wherein the holding structure includes a transversely-extending front retaining wall that bounds the media chamber and is part of the lower blocking structure.

4. The apparatus of claim 1 wherein the blocking structures include a transversely-extending upper blocking structure extending upward from a rear end of the top passageway, configured to block the liquid above the media chamber from flowing rearwardly onward to the rear end of the cavity without first flowing through the media chamber.

5. The apparatus of claim 4 further comprising a transversely-extending rear wall having lower and upper sections, the lower section being a part of the holding structure that bounds the media chamber and has flow holes defining the rear passageway, and the upper section being part of the upper blocking structure.

6. The apparatus of claim 1 further comprising a bypass passageway, in the cavity, through which the liquid can bypass the media chamber only when the liquid is above a predetermined level.

7. The apparatus of claim 1 wherein the holding structure includes a perforated cover structure extending completely over of the media chamber.

8. The apparatus of claim 7 wherein the cover structure includes a removable perforated cover plate extending over the media chamber.

9. The apparatus of claim 1 wherein the media chamber extends down to the bottom of the cavity.

10. The apparatus of claim 1 further comprising an outlet tube at the rear end of the cavity through which the liquid can exit the cavity, the outlet tube defining a horizontal outlet channel with a bottom that is above the top passageway of the holding structure.

11. The apparatus of claim 10 wherein the blocking structures include an upper blocking structure extending from a rear end of the top passageway up to a level above the bottom of the horizontal outlet channel.

12. The apparatus of claim 1 further comprising, in the media chamber, media for treating the liquid.

13. The apparatus of claim 12 wherein the media comprises coalescing media.

14. The apparatus of claim 12 wherein the media comprises chemical release agents.

15. The apparatus of claim 12 wherein the media comprises filtration media.

16. The apparatus of claim 12 further comprising, in the media chamber, a porous bag containing the media.
